(19) United States
(12) Patent Application Publication
(10) Pub. No.: US 2024/0137171 A1
(43) Pub. Date: Apr. 25, 2024

(54) SOUNDING REFERENCE SIGNAL ENHANCEMENT

(71) Applicant: ZTE Corporation, Shenzhen (CN)

(72) Inventors: Ke YAO, Shenzhen (CN); Shujuan ZHANG, Shenzhen (CN); Bo GAO, Shenzhen (CN); Meng MEI, Shenzhen (CN)

(21) Appl. No.: 18/394,496

(22) Filed: Dec. 22, 2023

Related U.S. Application Data
(63) Continuation of application No. PCT/CN2022/122898, filed on Sep. 29, 2022.

(51) Int. Cl. H04L 5/00; H04L 27/26

(52) U.S. Cl. CPC H04L 5/0048; H04L 27/2605

(57) ABSTRACT

Systems, methods, and apparatus for wireless communication are described. A wireless communication method includes determining, by a wireless device, one or more types of power control information, where each type of the one or more types of power control information includes one or more power control parameters for an uplink transmission. The method further includes determining, by the wireless device, based on the one or more types of power control information, a transmit power for the uplink transmission. The method further includes performing, by the wireless device, the uplink transmission using the transmit power. The described techniques may be adopted by a network device or by a wireless device.

### CROSS-REFERENCE TO RELATED APPLICATIONS

This application is a continuation of International Patent Application No. PCT/CN2022/122898, filed on Sep. 29, 2022, the contents of which are incorporated herein by reference in their entirety.

### TECHNICAL FIELD

This patent document is directed generally to digital wireless communications.

### BACKGROUND

Mobile telecommunication technologies are moving the world toward an increasingly connected and networked society. In comparison with the existing wireless networks, next generation systems and wireless communication techniques will need to support a much wider range of use-case characteristics and provide a more complex and sophisticated range of access requirements and flexibilities.

Long-Term Evolution (LTE) is a standard for wireless communication for mobile devices and data terminals developed by 3rd Generation Partnership Project (3GPP). LTE Advanced (LTE-A) is a wireless communication standard that enhances the LTE standard. The 5th generation of wireless system, known as 5G, advances the LTE and LTE-A wireless standards and is committed to supporting higher data-rates, large number of connections, ultra-low latency, high reliability, and other emerging business needs.

### SUMMARY

Techniques are disclosed for enhancing sounding reference signal (SRS) transmit power for transmission/reception point (TRP) common schemes.

A first example wireless communication method includes determining, by a wireless device, one or more types of power control information, where each type of the one or more types of power control information includes one or more power control parameters for an uplink transmission. The method further includes determining, by the wireless device, based on the one or more types of power control information, a transmit power for the uplink transmission. The method further includes performing, by the wireless device, the uplink transmission using the transmit power.

A second example wireless communication method includes transmitting, by a network device, one or more types of power control information, where each type of the one or more types of power control information includes one or more power control parameters for an uplink transmission. The method further includes receiving, by the network device, the uplink transmission with a transmit power based on the one or more types of power control information.

A third example wireless communication method includes determining, by a wireless device, a comb offset or a cyclic shift (CS) offset for a sounding reference signal (SRS) transmission over a SRS resource within a SRS resource set. The method further includes performing, by the wireless device, according to the comb offset or the CS offset, the SRS transmission.

A fourth example wireless communication method includes transmitting, by a network device, a comb offset or a cyclic shift (CS) offset for a sounding reference signal (SRS) transmission to be transmitted over a SRS resource within a SRS resource set. The method further includes receiving, by the network device, the SRS transmission based on the comb offset or the CS offset.

In yet another exemplary embodiment, a device that is configured or operable to perform the above-described methods is disclosed. The device may include a processor configured to implement the above-described methods.

In yet another exemplary embodiment, the above-described methods are embodied in the form of processor-executable code and stored in a non-transitory computer-readable storage medium. The code included in the computer readable storage medium when executed by a processor, causes the processor to implement the methods described in this patent document.

The above and other aspects and their implementations are described in greater detail in the drawings, the descriptions, and the claims.

### BRIEF DESCRIPTION OF THE DRAWINGS

FIG. 1 illustrates an exemplary transmission/reception point (TRP) common scheme.

FIGS. 2 and 3 illustrate exemplary transmit power calculations.

FIGS. 4-9 illustrate exemplary comb offset and cyclic shift (CS) offset assignments.

FIG. 10 is an exemplary flowchart for determining a transmit power.

FIG. 11 is an exemplary flowchart for transmitting power control information.

FIG. 12 is an exemplary flowchart for determining a comb offset or a CS offset.

FIG. 13 is an exemplary flowchart for transmitting a comb offset or a CS offset.

FIG. 14 illustrates an exemplary block diagram of a hardware platform that may be a part of a network device or a communication device.

FIG. 15 illustrates exemplary wireless communication including a Base Station (BS) and User Equipment (UE) based on some implementations of the disclosed technology.

### DETAILED DESCRIPTION

The example headings for the various sections below are used to facilitate the understanding of the disclosed subject matter and do not limit the scope of the claimed subject matter in any way. Accordingly, one or more features of one example section can be combined with one or more features of another example section. Furthermore, 5G terminology is used for the sake of clarity of explanation, but the techniques disclosed in the present document are not limited to 5G technology only, and may be used in wireless systems that implemented other protocols.

### I. Introduction

Issue 1: Current power control scheme is not suitable for transmission/reception point (TRP)-common sounding reference signal (SRS), and TRP-common physical uplink shared channel (PUSCH).
Issue 2: coexistence of SRS for a legacy user equipment (UE) and SRS for a new UE with cyclic shift (CS) hopping and/or comb hopping.

The new radio (NR) technology of the fifth generation (5G) mobile communication systems has continuously improved to provide higher quality wireless communication. One of the key features is the support of high frequency bands. High frequency bands have abundant frequency domain resources, but wireless signals in high frequency bands decay quickly and the coverage of the wireless signals becomes small. Transmitting signals in a beam mode is able to concentrate the energy in a relatively small spatial range and to improve the coverage of the wireless signals in the high frequency bands.

### II. Embodiment 1

Method of power control for TRP-common SRS.

### Issues:

In a legacy system, a set of power control parameters are configured for a SRS resource set. All SRS resources in the SRS resource set use the same set of power control parameters. In a multiple-TRP scenario, a SRS resource set is assumed to be for a TRP, so TRP-specific power control parameters are configured for a SRS resource set.

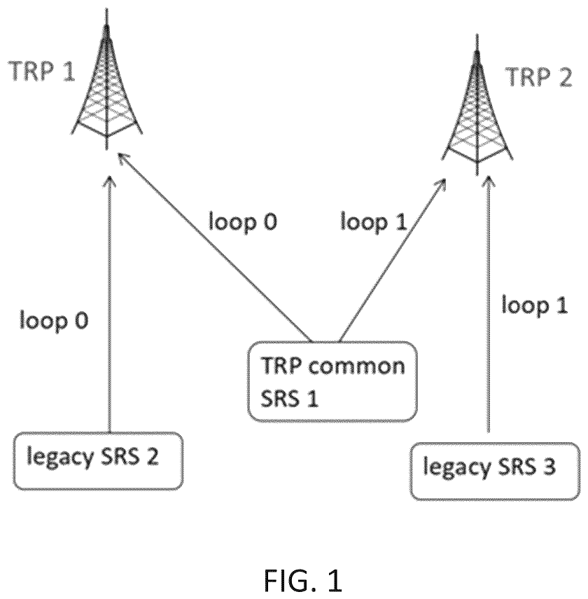

However, as shown in FIG. 1, in the case of TRP-common SRS, one SRS resource is communicated with more than one TRP, e.g., 2 TRPs. Current RRC-configured TRP-specific power control parameter scheme may not be suitable, since it only supports to configure a set of power control parameters considering one TRP. In reality, the TRP of configured power control parameters may cause lower transmission power than the power required by the other TRP, and SRS may not be received with good enough quality by the other TRP.

### Solutions:

A UE is configured by a network with a SRS resource set, and at least one type of the following parameters are associated with the SRS resource set, or with a SRS resource in the SRS resource set:

Open loop power control parameter, which may include at least one of target receiving power, P0, or ratio of path loss (PL) compensation, alpha.

Path loss parameter, which may include a RS for path loss estimation, PL-RS.

Closed loop power control parameter, which may include an index of closed loop power control.

The closed loop power control index for SRS can be shared with PUSCH, or the closed loop power control index for SRS can be separate from PUSCH.

For SRS-separate closed loop power control, the total number of closed loop power control can be larger than 1, e.g., 2, 4, or more. The total number of closed loop power control can be determined based on the number of TRPs for the TRP-common scenario. That means TRP-common SRS is assumed to be transmitted to a number of TRPs. The total number of closed loop power control for SRS can be equal to or larger than the number of TRPs.

Different closed loop power controls can be used for TRP-common SRS and non-TRP-common SRS.

For some types of the above parameters, the number of parameters can be 1, and the parameters are shared among all TRPs.

For some types of the above parameters, the number of parameters can be larger than 1, and the parameters are TRP-specific. For the parameters configured with the number of parameters larger than 1, the number of different types of parameters is the same.

In the case that the number of closed loop power control for SRS is larger than 1, e.g., 2, a UE is indicated with TPC (transmit power control) values from the network for closed loop power control for SRS for index 0 and 1.

UE calculates a number of transmit powers based on the power control parameters for a SRS, each for a TRP (or for an index of a type of parameter), and applies one transmit power, e.g., the highest value, the lowest value, or the average value of the number of transmit powers for the SRS transmission.

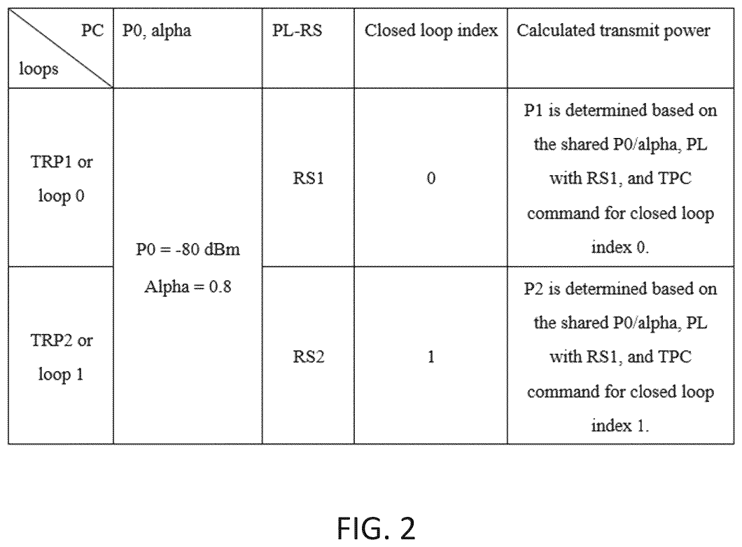

As shown in FIG. 2, P0, alpha is configured as shared parameters for two TRPs or loops, and there are 2 PL-RS and 2 closed loop indexes. And a UE can calculate 2 transmit powers.

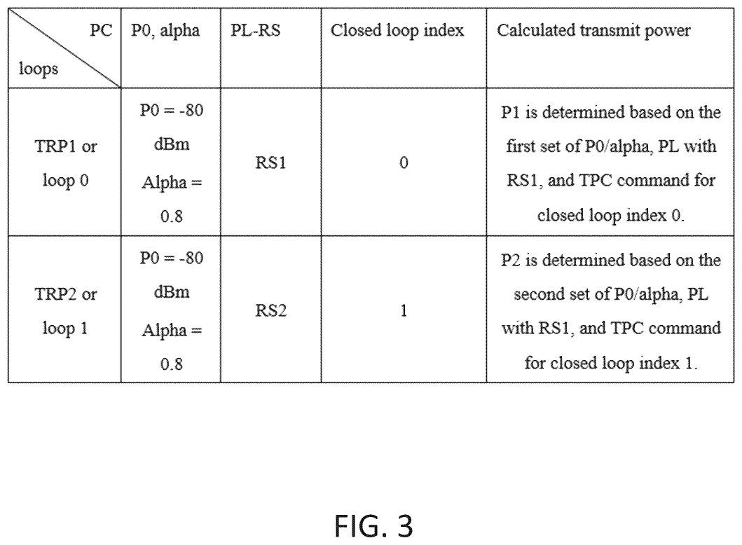

As shown in FIG. 3, P0, alpha can also be configured as separate parameters for two TRPs or loops, and there are 2 PL-RS and 2 closed loop indexes. And a UE can calculate 2 transmit powers. Considering the network can receive TRP-common SRS via different TRPs, P0 may be a lower value than that for normal SRS.

### III. Embodiment 2

Method of power control for TRP-common PUSCH.

Similarly, TRP-common PUSCH also needs multiple sets of power control parameters. That is one common beam for a PUSCH transmission but targeting different TRPs. The power control scheme is different from multi-TRP (mTRP) PUSCH.

In a legacy system, a set of PC parameters are associated with a SRI for PUSCH transmission.

In the case of TRP-common PUSCH, more than one set of PC parameters can be associated with a SRI (or TCI state) for PUSCH transmission. The more than one set of PC parameters may include one or more set of open loop power control parameters, one or more PL-RSs, or one or more closed loop power control indexes for PUSCH.

For some types of the above parameters, the number of parameters can be 1, and the parameters are shared among all TRPs.

For some types of the above parameters, the number of parameters can be larger than 1, and the parameters are TRP specific. For the parameters configured with the number of parameters larger than 1, the number of different types of parameters is the same.

In the case that the number of closed loop power control for PUSCH is larger than 1, e.g., 2, a UE is indicated with TPC (transmit power control) values from the network for closed loop power control for PUSCH for index 0 and 1.

UE calculates a number of transmit powers based on the power control parameters for an PUSCH transmission, each for a TRP (or for an index of a type of parameter), and applies one transmit power, e.g., the highest value, the lowest value, or the average value of the number of transmit powers for the PUSCH transmission.

A reference signal (RS) can be a synchronization signal block (SSB), a channel state information reference signal (CSI-RS), or a sounding reference signal (SRS). A transmission configuration indicator (TCI) state can be a beam state, or a RS resource indication.

The TRP includes at least one of information grouping reference signals, a PUCCH resource set, a reference signal resource set, a panel related information, a sub-array, an antenna group, an antenna port group, a group of antenna ports, a beam group, a physical cell index (PCI), a TRP related information, a CORESET pool index, a candidate cell, a candidate cell group, a time alignment group (TAG), a set of power control parameters, an index of a TCI state in a TCI state codepoint, a UE capability value, or a UE capability set.

The above power control scheme can also be used for a PUCCH. Power control parameters are associated with a PUCCH resource, a PUCCH resource group, or a TCI state associated with or applied to the PUCCH.

### IV. Embodiment 3

Method for coexistence of a legacy UE and a new UE with CS hopping and/or comb hopping.

### Background:

In a legacy system, SRS resource is configured with a higher layer parameter transmissionComb, which indicates the number of comb (K_{TC}), comb offset (i.e., a value of 0-(K_{TC}−1)), cyclic shift (can also be seen as cyclic shift offset, a value of 0−(n_{SRS}^{cs,max}−1)), where n_{SRS}^{cs,max} is the maximum number of cyclic shifts depending on the number of comb (K_{TC}).

In TS 38.211, the cyclic shift parameter is defined as:

The cyclic shift αᵢ for antenna port pᵢ is given as

$${α}_{i} = 2 π \frac{{n}_{SRS}^{cs , i}}{{n}_{SRS}^{cs , max}}$$

$${n}_{SRS}^{cs , i} = \{ \begin{matrix}\begin{matrix}( {n}_{SRS}^{cs} + \frac{{n}_{SRS}^{cs , max} ⌊ ( {p}_{i} - 1000 ) / 2 ⌋}{{N}_{ap}^{SRS} / 2} ) \\ mod {n}_{SRS}^{cs , max}\end{matrix} & if {N}_{ap}^{SRS} = 4 and {n}_{SRS}^{cs} = 6 \\ ( {n}_{SRS}^{cs} + \frac{{n}_{SRS}^{cs , max} ( {p}_{i} - 1000 )}{{N}_{ap}^{SRS}} ) mod {n}_{SRS}^{cs , max} & otherwise\end{matrix} ,$$

where n_{SRS}^{cs}∈{0, 1, . . . , n_{SRS}^{cs,max}−1} is contained in the higher layer parameter transmissionComb. The maximum number of cyclic shifts n_{SRS}^{cs,max} is given by Table 6.4.1.4.2-1.

TABLE 6.4.1.4.2-1
Maximum number of cyclic shifts n_{SRS}^{cs, max} as a function of K_{TC}.

| K_{TC} | n_{SRS}^{cs, max} |
|---|---|
| 2 | 8 |
| 4 | 12 |
| 8 | 6 |

In TS 38.331, a SRS resource configuration includes:

| transmissionComb | CHOICE { |
|---|---|
| n2 | SEQUENCE { |
| combOffset-n2 | INTEGER (0..1), |
| cyclicShift-n2 | INTEGER (0..7) |
| }, | |
| n4 | SEQUENCE { |
| combOffset-n4 | INTEGER (0..3), |
| cyclicShift-n4 | INTEGER (0..11) |
| } | |
| transmissionComb-n8-r17 | SEQUENCE { |
| combOffset-n8-r17 | INTEGER (0..7), |
| cyclicShift-n8-r17 | INTEGER (0..5) |

}

### Issue:

To improve the performance of SRS, comb hopping and/or CS hopping may be supported by an advanced UE (i.e., a new UE).

For example, for a setting: the number of comb (K_{TC}) is 2, n_{SRS}^{cs,max} is 8. A legacy UE can be configured with comb offset=0, and CS offset=0. A new UE which is configured with the same setting of K_{TC} and n_{SRS}^{cs,max}, comb hopping and/or CS hopping may be enabled. That means comb offset and/or CS offset can be a variable for different time points or different SRS counters (i.e., n_{SRS}). E.g., a value pair of (comb offset, CS offset) can be changed with an order of: (0, 0), (0, 1), . . . , (0, 7), (1, 0), (1, 1), . . . , (1, 7).

Transmission comb number K_{TC} can be an integer value of 2, 4, or 8. E.g., for a value of K_{TC}, the first set can be {0, 1, . . . K_{TC}−1}.

The maximum number of cyclic shifts n_{SRS}^{cs,max} can be an integer value of 8, 12 or 6. E.g., for a value of n_{SRS}^{cs,max} maximum number of cyclic shifts, the second set can be {0, 1, . . . n_{SRS}^{cs,max}−1}.

If the legacy UE and the new UE are allocated in the same RE (resource element), some SRS for the new UE may collide with the legacy UE, which means the legacy UE and the new UE may have the same value pair of (comb offset, CS offset).

In a word, there may be an issue for the coexistence of SRS for a legacy UE and SRS for a new UE with CS hopping and/or comb hopping.

### Solution:

Scheme 1: only one of CS hopping or comb hopping can be enabled.

When CS hopping is enabled, and comb hopping is disabled, some comb offset values are for the legacy UE, while other comb offset values are for the new UE.

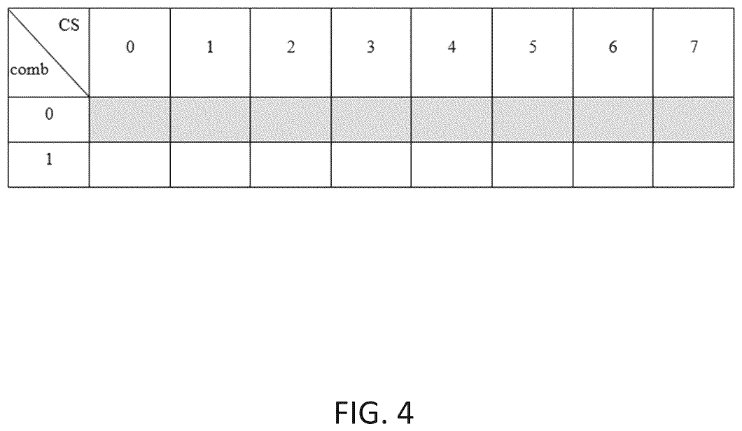

For example, the gray part, comb offset=0 in FIG. 4 is for the new UE. CS offset can be hopping for such comb offset settings. The other comb offset settings are for the legacy UE, and CS offset is not hopping.

When comb hopping is enabled, and CS hopping is disabled, some CS offset values are for the legacy UE, while other CS offset values are for the new UE.

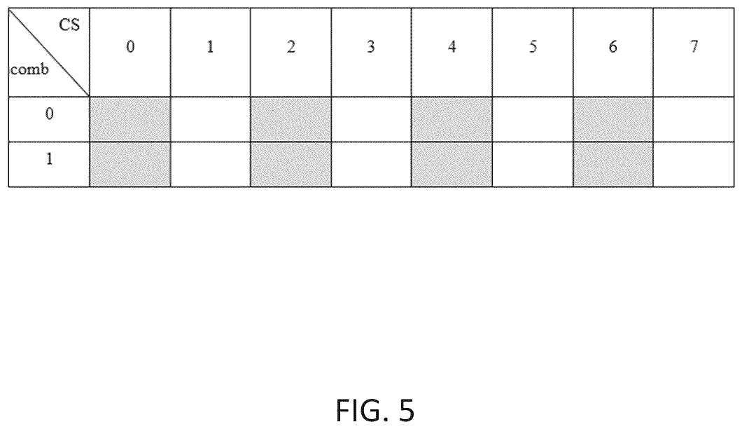

For example, the gray part, CS offset=0, 2, 4, and 6 in FIG. 5 is for the new UE. Comb offset can be hopping for such CS offset settings. The other CS offset settings are for the legacy UE, and comb offset is not hopping.

Scheme 2: only part of CS offset values and/or comb offset values can be used for hopping.

There is no restriction that only one of CS hopping or comb hopping is enabled as in Scheme 1. There are a set of CS offset values which includes values from 0 to (n_{SRS}^{cs,max}−1), and a set of comb offset values which includes values from 0 to (K_{TC}−1).

Part of CS offset values and/or comb offset values can be used for hopping. At least one of the following items can be used to determine the part of CS offset values and/or comb offset values for hopping:

The part of CS offset values can be configured or predetermined by a CS offset pattern which indicates a subset of a set of CS offset values.

The part of comb offset values can be configured or predetermined by a comb offset pattern which indicates a subset of a set of comb offset values.

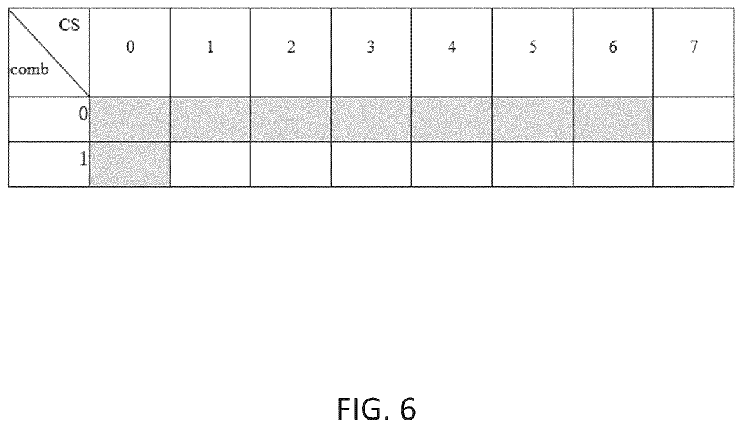

For one or more comb offset values, the part of CS offset values can be configured or predetermined by a CS offset pattern which indicates a subset of a set of CS offset values. Different comb offset values may have different parts of CS offset values. E.g., as shown in FIG. 6, for comb offset 0, CS offset values of 0˜6 are indicated as for hopping, and for comb offset 1, CS offset value of 0 is indicated as for hopping.

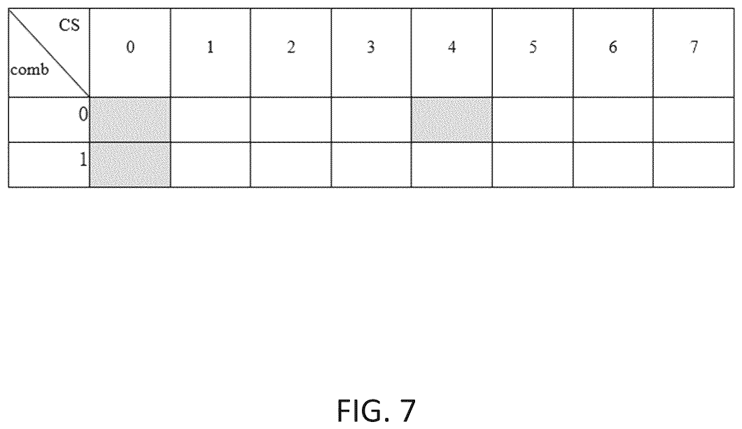

For one or more CS offset values, the part of comb offset values can be configured or predetermined by a comb offset pattern which indicates a subset of a set of comb offset values. Different CS offset values may have different parts of comb offset values. E.g., as shown in FIG. 7, for CS offset 0, comb offset values of 0˜1 are indicated as for hopping, and for CS offset 4, comb offset value of 0 is indicated as for hopping.

CS offset values and comb offset values for hopping can be indicated by a joint indication of CS offset and comb offset.

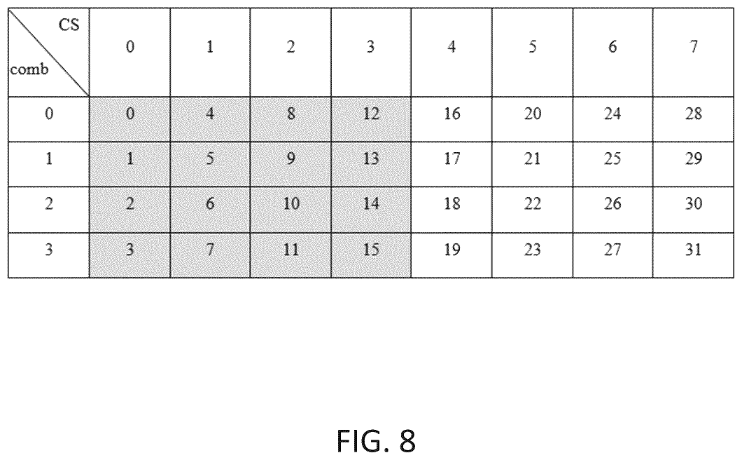

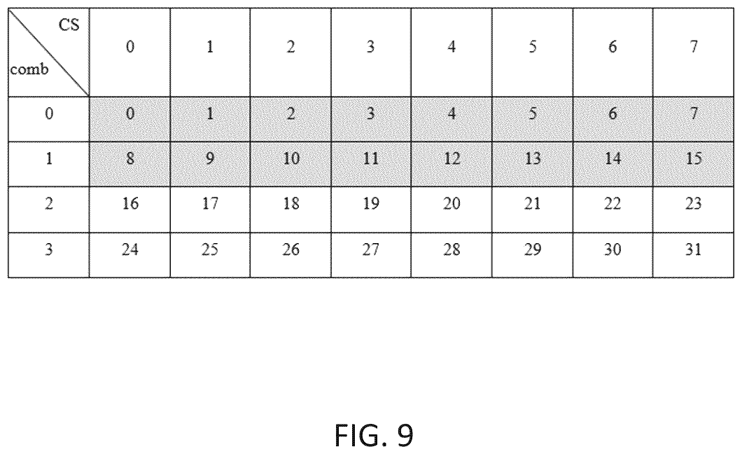

For example, a CS offset and a comb offset are jointly indicated by a comb-CS hopping resource index. The resources can be indexed by increasing the order of CS offset values first and increasing comb offset values second, as in FIG. 8, or increasing the order of comb offset values first and increasing CS offset values second, as in FIG. 9.

For example, the first half of comb-CS hopping resource indexes are indicated for hopping, as shown by gray elements in FIG. 8 and FIG. 9.

CS offset values and/or comb offset values used for hopping can be determined by at least one of a CS offset pattern, a comb offset pattern, or a comb-CS hopping resource index.

The CS offset pattern, the comb offset pattern, or the comb-CS hopping resource index can be configured, predefined, or predetermined for hopping.

The CS offset pattern, the comb offset pattern, or the comb-CS hopping resource index can be configured, predefined, or predetermined for hopping based on a number of CS offset values, a number of comb offset values, or a number of comb-CS hopping resources respectively. The number of CS offset values, the number of comb offset values, or the number of comb-CS hopping resources can be determined by a certain order and a certain starting index, e.g., from index 0, to the corresponding number.

The CS offset pattern, the comb offset pattern, or the comb-CS hopping resource index can be determined for a SRS resource, or for a SRS resource set. If for a SRS resource set, the CS offset pattern, the comb offset pattern, or the comb-CS hopping resource index can be determined for all SRS resources in the SRS resource set. Or part of the SRS resources in the SRS resource set can be determined with hopping patterns according to the CS offset pattern, the comb offset pattern, or the comb-CS hopping resource index.

The subset of CS offset values and/or comb offset values for hopping can be determined according to the number of SRS ports in a SRS resource.

Only the initial position for comb offset and/or CS offset is provided, e.g., for a port of a SRS resource. The CS offset pattern, the comb offset pattern, or the comb-CS hopping resource index can be determined for one port index of a SRS resource, e.g., the first port index, SRS port #0, or another predetermined port index, for obtaining CS offset and comb offset. And the CS offset and comb offset for other port index(es) of the SRS resource can be determined based on the CS offset and comb offset for the one port index of the SRS resource.

If a CS offset pattern, a comb offset pattern, or a comb-CS hopping resource index is determined for one port index of a SRS resource, a set of comb-CS hopping resources are reserved for all ports in the SRS resource.

For example, if CS offset 0 is configured for a SRS resource which supports 2 SRS ports, then CS offset 0 and CS offset 1 (or another CS offset value) are determined for port 0 and port 1 of the SRS resource respectively.

The subset may be selected or predetermined from a candidate subset(s), e.g., a Table for a respective “number of SRS ports.”

The subset may be determined by a parameter in the DCI or dynamically indicated by DCI/MAC-CE.

The CS and/or comb hop pattern is determined according to an index of OFDM symbol (SRS position in a slot, symbol index is a value relative to the starting of a slot), a slot index, a frame index, and/or a SRS counter n_{SRS}.

For example, the cyclic shift αᵢ for antenna port pᵢ is given as

$${α}_{i} = 2 π \frac{{n}_{SRS}^{cs , i}}{{n}_{SRS}^{cs , max}}$$

where

$${n}_{SRS}^{cs , i} = ( {n}_{SRS}^{cs} + f ( t ) + \frac{{n}_{SRS}^{cs , max} ⌊ ( {p}_{i} - 1000 ) / 2 ⌋}{{N}_{ap}^{SRS} / 2} ) mod {n}_{SRS}^{cs , max} , or$$

$${n}_{SRS}^{cs , i} = ( {n}_{SRS}^{cs} + f ( t ) + \frac{{n}_{SRS}^{cs , max} ( {p}_{i} - 1000 )}{{N}_{ap}^{SRS}} ) mod {n}_{SRS}^{cs , max}$$

where f(t) is a time domain parameter related value, which is determined according to an OFDM symbol index, a slot index, a frame index, or a SRS counter, n_{SRS}.

f(t) is equal to an OFDM symbol index, a slot index, a frame index, or a SRS counter, n_{SRS} of an SRS transmission.

f(t) is determined by a modular operation on a value related to at least one of an OFDM symbol index, a slot index, a frame index, or a SRS counter, n_{SRS} of an SRS transmission. And the module is determined by n_{SRS}^{cs,max}, or a fraction of n_{SRS}^{cs,max}, or a number configured by a network (or gNB).

A CS offset value can be a value of a SRS sequence level. For example, n_{SRS}^{cs,max} can be

a value of (8, 12, 6), while a length of a SRS sequence can be 120. Then the CS offset value can be one of (0, 1, . . . , 119). Different ports are equally allocated almost equally on the whole SRS sequence. In that case, the formula of CS offset value can be SRS sequence level, which means another domain of n_{SRS}^{cs}, or n_{SRS}^{cs,max}.

An OFDM symbol index of a SRS transmission is a SRS position in a slot. It is a symbol index relative to the starting of the slot.

A slot/frame index of a SRS transmission refers to the slot/frame which the SRS transmission is carried on.

A SRS counter is an index of a SRS transmission. Several SRS repetitions may have the same SRS counter or separate SRS counters.

### V. Embodiment 4

Method to support SRS closed loop power control indication with TCI state

If a UE is provided with a unified TCI State, the power control parameters are determined based on the indicated TCI state, i.e., the unified TCI state. Currently, a closed loop power control parameter is provided in a same format for a PUSCH, a PUCCH, and a SRS, as follows:

P0AlphaSet-r17 ::= SEQUENCE {

| | | |
|---|---|---|
| p0-r17 | INTEGER (−16..15) | OPTIONAL, -- Need R |
| alpha-r17 | Alpha | OPTIONAL, -- Need R |

| | |
|---|---|
| closedLoopIndex-r17 | ENUMERATED { i0, i1 }} |

For a PUSCH or a PUCCH, it is easy to understand that i0 or i1 indicates the first or the second closed loop power control respectively. However, for a SRS, it may need to support a separate SRS closed loop power control or a shared closed power control with a PUSCH (either one of the PUSCH closed power control, i0 or i1). Currently there are two types of SRS: SRS following a unified TCI, SRS not following a unified TCI. The SRS following a unified TCI tends to share a closed loop power control with a PUSCH. While the SRS not following a unified TCI includes the SRS for beam management which should have a separate closed loop power control, and the closed loop power control parameter is indicated by a TCI state. Therefore, a closed loop power control parameter associated with a TCI state for a SRS should support both a separate and a shared closed loop power control. However, the current technology cannot support such an indication.

The solution can be:

UE receives power control information for a SRS associated with or included in a TCI state. The power control information for the SRS may include a closed loop power control parameter for the SRS, e.g., closedLoopIndex-r1.

The UE determines a closed loop power control parameter for a SRS, i.e., a SRS power control adjustment state with index l=0 or 1, with a separate closed loop power control for the SRS, or with a shared closed loop power control for a PUSCH, according to at least one of the following:

A closed loop power control parameter for the SRS indicates a shared closed loop power control for a PUSCH, e.g., with a closed loop power control index of 0 or 1 for the value of a closed loop power control parameter being i0 or i1;

An absence of a closed loop power control parameter for the SRS indicates a separate closed loop power control for the SRS, e.g., with a closed loop power control index of 0;

A closed loop power control parameter for the SRS indicates a shared closed loop power control for a PUSCH, e.g., with a closed loop power control index of 0 or 1 for the value of a closed loop power control parameter being i0 or i1, in response to the value of the closed loop power control parameter for the SRS being equal to the value of the closed loop power control parameter for the PUSCH in the TCI state;

A closed loop power control parameter for the SRS indicates a separate closed loop power control for the SRS, e.g., with a closed loop power control index of 0, in response to the value of the closed loop power control parameter for the SRS being different from the value of the closed loop power control parameter for the PUSCH in the TCI state; or

A first value of (i0, or i1) closed loop power control parameter for the SRS indicates a shared closed loop power control for a PUSCH with a closed loop power control index of 0 or 1, and an absence of a closed loop power control parameter for the SRS indicates another shared closed loop power control for the PUSCH with a closed loop power control index of 1 or 0, and another value of (i0, or i1) different from the first value of closed loop power control parameter for the SRS indicates a separate closed loop power control for the SRS with a closed loop power control index of 0.

The TCI state is associated with the SRS. E.g., the TCI state is an indicated TCI state or a unified TCI state indicated by a DCI or activated by a MAC CE. The SRS is enabled to follow the unified TCI state. Or the TCI state is associated with a SRS resource with a lowest SRS-ResourceId in the SRS resource set, e.g., in the case that the SRS is disabled to follow the unified TCI state.

The above solution can be applied to one or both of the two types of SRS: a SRS following a unified TCI, and a SRS not following a unified TCI.

The above solution can be applied to a SRS according to the usage of the SRS resource set which includes the SRS. E.g., for the usage of beam management, only a separate closed loop power control for the SRS can be used. For the usage of codebook base, non codebook base, or antenna switching, only a shared closed loop power control with a PUSCH can be used, or both a separate and a shared closed loop power control can be used.

A separate closed loop power control for a SRS refers to the case where a TPC (transmit power control) command for the SRS is used to update a SRS power control adjustment state l.

A shared closed loop power control for a PUSCH or with a PUSCH refers to the case where a TPC (transmit power control) command for the PUSCH is used to update a PUSH power control adjustment state l, and can be reused to determine a transmit power for the SRS.

For TRP-common SRS/PUSCH, more than one type of power control parameter can be configured. A UE determines a transmit power based on more than one calculated transmit power based on the configured power control parameters.

Part of comb offset values and/or part of CS offset values can be indicated for hopping. A subset of comb offset values and/or CS offset values can be configured by a separate pattern or a combined pattern.

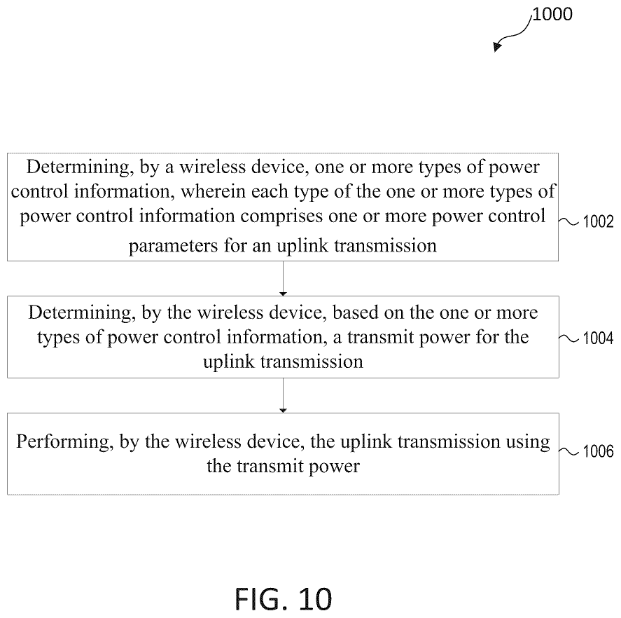

FIG. 10 is an exemplary flowchart for determining a transmit power. Operation 1002 includes determining, by a wireless device, one or more types of power control information, where each type of the one or more types of power control information includes one or more power control parameters for an uplink transmission. Operation 1004 includes determining, by the wireless device, based on the one or more types of power control information, a transmit power for the uplink transmission. Operation 1006 includes performing, by the wireless device, the uplink transmission using the transmit power. In some embodiments, the method can be implemented according to Embodiments 1 and 2. In some embodiments, performing further steps of the method can be based on a better system performance than a legacy protocol.

In some embodiments, one of the one or more types of power control information includes at least one of an open loop power control parameter including a target receiving power or a ratio of path loss (PL) compensation, a PL parameter including a reference signal (RS) for a PL estimation, or a closed loop power control parameter including an index of a closed power control or a transmit power control (TPC) command for the index of the closed loop power control.

In some embodiments, the one or more types of power control information are associated with at least one of a sounding reference signal (SRS) resource, a SRS resource set, a beam state for a SRS, a physical control channel resource, a physical control channel resource group, a beam state for a physical control channel, or a beam state for a physical shared channel. In some embodiments, each of the beam state for the SRS, the beam state for the physical control channel, and the beam state for the physical shared channel includes at least one of a transmission configuration indicator (TCI) state, a beam, a quasi-co-location (QCL) state, a spatial relation state, a reference signal (RS), a spatial filter, or a pre-coding information.

In some embodiments, the uplink transmission includes at least one of a sounding reference signal (SRS), a physical shared channel, or a physical control channel. In some embodiments, one of the one or more types of power control information includes one transmission/reception point (TRP) common power control parameter. In some embodiments, one of the one or more types of power control information includes more than one transmission/reception point (TRP) specific power control parameter.

In some embodiments, determining the transmit power includes determining a highest, a lowest, or an average transmit power of one or more transmit powers corresponding to the one or more power control parameters according to the one or more types of power control information. In some embodiments, one of the one or more types of power control information includes an integer number of transmission/reception point (TRP) specific power control parameters, and determining the transmit power includes determining an integer number of transmit powers corresponding to the integer number of TRP specific power control parameters and determining the transmit power based on the integer number of transmit powers. In some embodiments, determining the transmit power based on the integer number of transmit powers includes determining a highest, a lowest, or an average transmit power of the integer number of transmit powers.

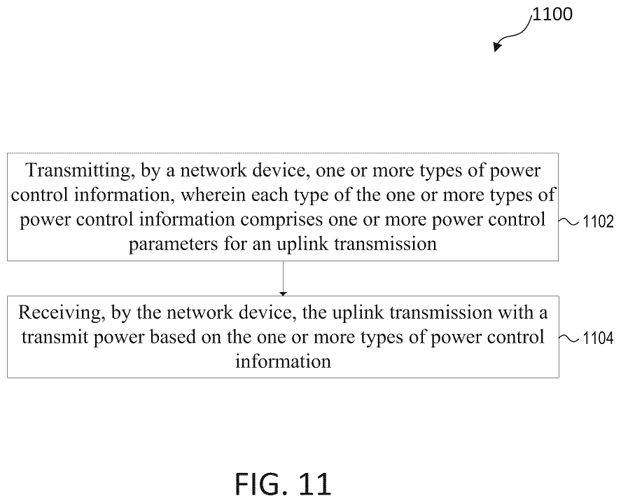

FIG. 11 is an exemplary flowchart for transmitting power control information. Operation 1102 includes transmitting, by a network device, one or more types of power control information, where each type of the one or more types of power control information includes one or more power control parameters for an uplink transmission. Operation 1104 includes receiving, by the network device, the uplink transmission with a transmit power based on the one or more types of power control information. In some embodiments, the method can be implemented according to Embodiments 1 and 2. In some embodiments, performing further steps of the method can be based on a better system performance than a legacy protocol.

In some embodiments, one of the one or more types of power control information includes at least one of an open loop power control parameter including a target receiving power or a ratio of path loss (PL) compensation, a PL parameter including a reference signal (RS) for a PL estimation, or a closed loop power control parameter including an index of a closed power control or a transmit power control (TPC) command for the index of the closed loop power control.

In some embodiments, the one or more types of power control information are associated with at least one of a sounding reference signal (SRS) resource, a SRS resource set, a beam state for a SRS, a physical control channel resource, a physical control channel resource group, a beam state for a physical control channel, or a beam state for a physical shared channel. In some embodiments, each of the beam state for the SRS, the beam state for the physical control channel, and the beam state for the physical shared channel includes at least one of a transmission configuration indicator (TCI) state, a beam, a quasi-co-location (QCL) state, a spatial relation state, a reference signal (RS), a spatial filter, or a pre-coding information.

In some embodiments, the uplink transmission includes at least one of a sounding reference signal (SRS), a physical shared channel, or a physical control channel. In some embodiments, one of the one or more types of power control information includes one transmission/reception point (TRP) common power control parameter. In some embodiments, one of the one or more types of power control information includes more than one transmission/reception point (TRP) specific power control parameter. In some embodiments, the transmit power is a highest, a lowest, or an average transmit power of one or more transmit powers corresponding to the one or more power control parameters according to the one or more types of power control information.

In some embodiments, one of the one or more types of power control information includes an integer number of transmission/reception point (TRP) specific power control parameters, and the transmit power is based on an integer number of transmit powers corresponding to the integer number of TRP specific power control parameters. In some embodiments, the transmit power is a highest, a lowest, or an average transmit power of the integer number of transmit powers.

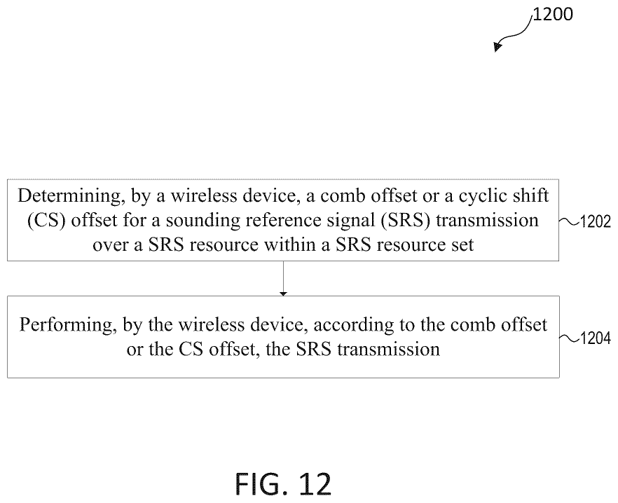

FIG. 12 is an exemplary flowchart for determining a comb offset or a CS offset. Operation 1202 includes determining, by a wireless device, a comb offset or a cyclic shift (CS) offset for a sounding reference signal (SRS) transmission over a SRS resource within a SRS resource set. Operation 1204 includes performing, by the wireless device, according to the comb offset or the CS offset, the SRS transmission. In some embodiments, the method can be implemented according to Embodiment 3. In some embodiments, performing further steps of the method can be based on a better system performance than a legacy protocol.

In some embodiments, determining the comb offset or the CS offset for the SRS transmission includes determining the comb offset or the CS offset for a port index of the SRS transmission. In some embodiments, determining the comb offset or the CS offset for the SRS transmission includes determining the comb offset or the CS offset based on at least one of an orthogonal frequency-division multiplexing (OFDM) symbol index of the SRS transmission, a slot index of the SRS transmission, a frame index of the SRS transmission, or a SRS counter of the SRS transmission.

In some embodiments, the method further includes determining, by the wireless device, a comb offset value set, a CS offset value set, or a comb offset and CS offset value set for the SRS resource or the SRS resource set. In some embodiments, the comb offset value set includes the comb offset, the CS offset value set includes the CS offset, and the comb offset and CS offset value set includes the comb offset and the CS offset. In some embodiments, the comb offset value set is a subset of a first set determined by a transmission comb number, the CS offset value set is a subset of a second set determined by a maximum number of CSs, and the comb offset and CS offset value set is a subset of a third set determined by the transmission comb number and the maximum number of CSs.

In some embodiments, the method further includes receiving a network message, where the comb offset value set, the CS offset value set, or the comb offset and CS offset value set is determined based on the network message. In some embodiments, the comb offset value set, the CS offset value set, or the comb offset and CS offset value set is determined based on a predetermined rule.

In some embodiments, the method further includes determining, by the wireless device, a CS offset value set for the comb offset, or determining, by the wireless device, a comb offset value set for the CS offset. In some embodiments, the method further includes determining, by the wireless device, another comb offset or another CS offset. The method further includes determining, by the wireless device, another CS offset value set for the other comb offset, where the other CS offset value set is different from the CS offset value set. The method further includes determining, by the wireless device, another comb offset value set for the other CS offset, where the other comb offset value set is different from the comb offset value set.

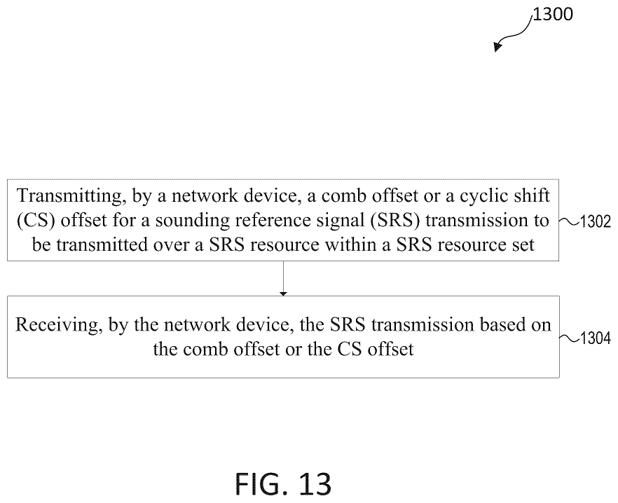

FIG. 13 is an exemplary flowchart for transmitting a comb offset or a CS offset. Operation 1302 includes transmitting, by a network device, a comb offset or a cyclic shift (CS) offset for a sounding reference signal (SRS) transmission to be transmitted over a SRS resource within a SRS resource set. Operation 1304 includes receiving, by the network device, the SRS transmission based on the comb offset or the CS offset. In some embodiments, the method can be implemented according to Embodiment 3. In some embodiments, performing further steps of the method can be based on a better system performance than a legacy protocol.

In some embodiments, the comb offset or the CS offset for the SRS transmission is associated with a port index of the SRS transmission. In some embodiments, the comb offset or the CS offset for the SRS transmission is based on at least one of an orthogonal frequency-division multiplexing (OFDM) symbol index of the SRS transmission, a slot index of the SRS transmission, a frame index of the SRS transmission, or a SRS counter of the SRS transmission.

In some embodiments, the method further includes transmitting, by the network device, a comb offset value set, a CS offset value set, or a comb offset and CS offset value set for the SRS resource or the SRS resource set. In some embodiments, the comb offset value set includes the comb offset, the CS offset value set includes the CS offset, and the comb offset and CS offset value set includes the comb offset and the CS offset. In some embodiments, the comb offset value set is a subset of a first set based on a transmission comb number, the CS offset value set is a subset of a second set based on a maximum number of CSs, and the comb offset and CS offset value set is a subset of a third set based on the transmission comb number and the maximum number of CSs.

In some embodiments, the method further includes transmitting a network message, where the comb offset value set, the CS offset value set, or the comb offset and CS offset value set is based on the network message. In some embodiments, the comb offset value set, the CS offset value set, or the comb offset and CS offset value set is based on a predetermined rule.

In some embodiments, the method further includes transmitting, by the network device, a CS offset value set for the comb offset, or transmitting, by the network device, a comb offset value set for the CS offset. In some embodiments, the method further includes transmitting, by the network device, another comb offset or another CS offset. The method further includes transmitting, by the network device, another CS offset value set for the other comb offset, where the other CS offset value set is different from the CS offset value set. The method further includes transmitting, by the network device, another comb offset value set for the other CS offset, where the other comb offset value set is different from the comb offset value set.

A device that is configured or operable to perform the above-described methods are within the scope and the spirit of this patent document.

In some embodiments, the above-described methods are embodied in the form of processor-executable code and stored in a non-transitory computer-readable storage medium. The code included in the computer readable storage medium when executed by a processor, causes the processor to implement the methods described in this patent document.

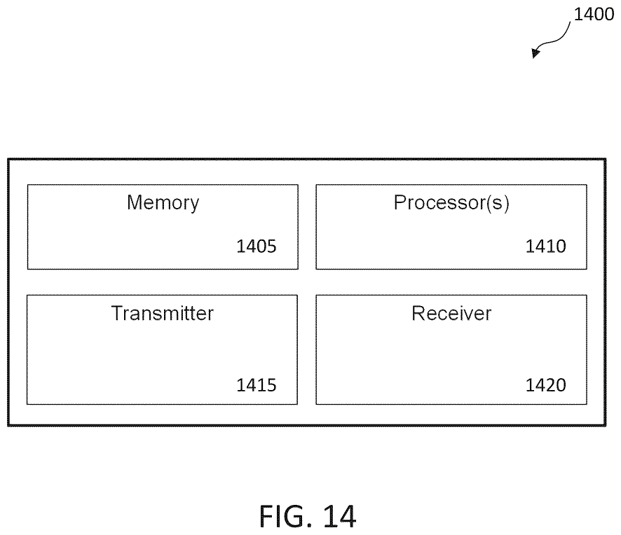

FIG. 14 shows an exemplary block diagram of a hardware platform 1400 that may be a part of a network device (e.g., base station) or a communication device (e.g., a user equipment (UE)). The hardware platform 1400 includes at least one processor 1410 and a memory 1405 having instructions stored thereupon. The instructions upon execution by the processor 1410 configure the hardware platform 1400 to perform the operations described in FIGS. 1 to 13 and in the various embodiments described in this patent document. The transmitter 1415 transmits or sends information or data to another device. For example, a network device transmitter can send a message to a user equipment. The receiver 1420 receives information or data transmitted or sent by another device. For example, a user equipment can receive a message from a network device. For example, a UE or a TRP, as described in the present document, may be implemented using the hardware platform 1400.

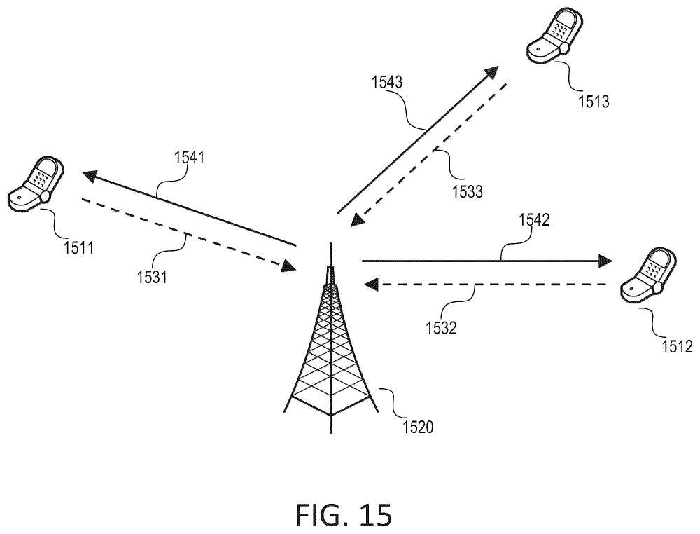

The implementations as discussed above will apply to a wireless communication. FIG. 15 shows an example of a wireless communication system (e.g., a 5G or NR cellular network) that includes a base station 1520 and one or more user equipment (UE) 1511, 1512 and 1513. In some embodiments, the UEs access the BS (e.g., the network) using a communication link to the network (sometimes called uplink direction, as depicted by dashed arrows 1531, 1532, 1533), which then enables subsequent communication (e.g., shown in the direction from the network to the UEs, sometimes called downlink direction, shown by arrows 1541, 1542, 1543) from the BS to the UEs. In some embodiments, the BS send information to the UEs (sometimes called downlink direction, as depicted by arrows 1541, 1542, 1543), which then enables subsequent communication (e.g., shown in the direction from the UEs to the BS, sometimes called uplink direction, shown by dashed arrows 1531, 1532, 1533) from the UEs to the BS. The UE may be, for example, a smartphone, a tablet, a mobile computer, a machine to machine (M2M) device, an Internet of Things (IoT) device, and so on. The UEs described in the present document may be communicatively coupled (e.g., as shown in FIG. 1) to the base station 1520 depicted in FIG. 15.

In this document the term “exemplary” is used to mean “an example of” and, unless otherwise stated, does not imply an ideal or a preferred embodiment.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described and other implementations, enhancements and variations can be made based on what is described and illustrated in this disclosure.

What is claimed is:

1. A method of wireless communication, comprising:
determining, by a wireless device, a comb offset or a cyclic shift (CS) offset for a sounding reference signal (SRS) transmission over a SRS resource within a SRS resource set; and
performing, by the wireless device, according to the comb offset or the CS offset, the SRS transmission.

2. The method of claim 1, wherein determining the comb offset or the CS offset for the SRS transmission comprises determining the comb offset or the CS offset based on an orthogonal frequency-division multiplexing (OFDM) symbol index of the SRS transmission, a slot index of the SRS transmission, and a frame index of the SRS transmission.

3. The method of claim 1, further comprising:
determining, by the wireless device, a comb offset value set or a CS offset value set for the SRS resource.

4. The method of claim 3, wherein the comb offset value set comprises the comb offset, wherein the CS offset value set comprises the CS offset.

5. The method of claim 3, wherein the comb offset value set is a subset of a first set determined by a transmission comb number, and wherein the CS offset value set is a subset of a second set determined by a maximum number of CSs.

6. The method of claim 3, further comprising:
receiving a network message, wherein the comb offset value set, the CS offset value set, is determined based on the network message.

7. The method of claim 3, wherein the comb offset value set or the CS offset value set is determined based on a predetermined rule.

8. The method of claim 1, further comprising:
determining, by the wireless device, a CS offset value set for the comb offset.

9. An apparatus for wireless communication, comprising a processor, wherein the processor is configured to implement a method, the processor configured to:
determine, by a wireless device, a comb offset or a cyclic shift (CS) offset for a sounding reference signal (SRS) transmission over a SRS resource within a SRS resource set; and
perform, by the wireless device, according to the comb offset or the CS offset, the SRS transmission.

10. The apparatus of claim 9, wherein determining the comb offset or the CS offset for the SRS transmission comprises determining the comb offset or the CS offset based on an orthogonal frequency-division multiplexing (OFDM) symbol index of the SRS transmission, a slot index of the SRS transmission, and a frame index of the SRS transmission.

11. The apparatus of claim 9, wherein the processor is further configured to:
determine, by the wireless device, a comb offset value set or a CS offset value set for the SRS resource.

12. The apparatus of claim 11, wherein the comb offset value set comprises the comb offset, wherein the CS offset value set comprises the CS offset.

13. The apparatus of claim 11, wherein the comb offset value set is a subset of a first set determined by a transmission comb number, and wherein the CS offset value set is a subset of a second set determined by a maximum number of CSs.

14. The apparatus of claim 11, wherein the processor is further configured to:
receive a network message, wherein the comb offset value set, the CS offset value set, is determined based on the network message.

15. The apparatus of claim 9, wherein the comb offset value set or the CS offset value set is determined based on a predetermined rule.

16. The apparatus of claim 9, wherein the processor is further configured to:
determine, by the wireless device, a CS offset value set for the comb offset.

17. A non-transitory computer readable program storage medium having code stored thereon, the code, when executed by a processor, causing the processor to implement a method, comprising:
determining, by a wireless device, a comb offset or a cyclic shift (CS) offset for a sounding reference signal (SRS) transmission over a SRS resource within a SRS resource set; and
performing, by the wireless device, according to the comb offset or the CS offset, the SRS transmission.

18. The non-transitory computer readable program storage medium of claim 17, wherein determining the comb offset or the CS offset for the SRS transmission comprises determining the comb offset or the CS offset based on an orthogonal frequency-division multiplexing (OFDM) symbol index of the SRS transmission, a slot index of the SRS transmission, and a frame index of the SRS transmission.

19. The non-transitory computer readable program storage medium of claim 17, wherein the method further comprises:
determining, by the wireless device, a comb offset value set or a CS offset value set for the SRS resource.

20. The non-transitory computer readable program storage medium of claim 19, wherein the comb offset value set comprises the comb offset, wherein the CS offset value set comprises the CS offset.
